(19) United States
(12) Patent Application Publication
(10) Pub. No.: US 2006/0178070 A1
(43) Pub. Date: Aug. 10, 2006

(54) Nonwoven fabric, fiber and galvanic cell

(75) Inventors: Peter Kritzer, Forst (DE); Hans-Joachim Feistner, Abtsteinach (DE); Holger Schilling, Heitersheim (DE); Michael Kalbe, Sant Cugat (ES)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 11/350,139

(22) Filed: Feb. 8, 2006

(30) Foreign Application Priority Data
Feb. 8, 2005 (DE) DE102005005852.3

(51) Int. Cl. D04H 13/00; B32B 5/26; D04H 1/56; D04H 3/16; D04H 1/00

(52) U.S. Cl. 442/414; 442/361; 442/362; 442/364; 442/382; 442/400; 442/401

(57) ABSTRACT

A nonwoven fabric, in particular for use as a separator in batteries or galvanic cells, having functional fibers made of at least one fibrous material which intrinsically contains at least one substance that is chemically active or activatable in an alkaline medium. The substance is incorporated surface-actively exclusively in volumetric regions of the functional fibers whose surface areas are able to be acted upon by the medium. A fiber is made from the mentioned fibrous material. A galvanic cell contains this nonwoven fabric as a separator.

### CROSS REFERENCE TO RELATED APPLICATION

This application claims the benefit of German Patent 10 2005 005 852.3 filed Feb. 8, 2005 and hereby incorporated by reference herein.

The present invention provides a nonwoven fabric, in particular for use as a separator in batteries or galvanic cells, having functional fibers made of at least one fibrous material which intrinsically contains at least one substance that is chemically active or activatable in an alkaline medium. The present invention also provides a fiber having a fibrous material which intrinsically contains at least one substance that is chemically active or activatable in an alkaline medium. Finally, the present invention provides a galvanic cell, in particular a battery, having a casing, the casing at least partially accommodating one positive and one negative electrode, as well as a material that permits the transport of charge carriers, and a separator separating the electrodes, the separator including a nonwoven fabric or at least one fiber.

### BACKGROUND OF THE INVENTION

Alkaline batteries or cells require separator materials that have special properties. These properties include resistance to the electrolyte, resistance to oxidation, high mechanical stability, low thickness tolerance, low resistance to the passage of ions, high resistance to the passage of electrons, retention capacity for solid particles coming off of the electrodes, permanent wettability by the electrolyte, and high storage capacity for the electrolyte liquid.

Depending on the polymer used to manufacture the separator, however, various advantages and disadvantages are associated with such separator materials. Thus, for example, separators made of polyolefins exhibit excellent resistance to chemical attack by highly alkaline electrolytes and to oxidation in the chemical environment of the cells. However, they exhibit poor wettability by the alkaline electrolyte. In contrast, polyamide always exhibits satisfactory wettability, but has inferior hydrolytic stability, especially at elevated temperatures.

When used in nickel-metal-hydride or nickel-cadmium storage batteries, the separator must perform an additional task. The disadvantage of an accelerated self-discharging arises in such storage batteries. Ions transport the charges in the electrolyte from the negative cadmium or metal-hydride electrode to the positive nickel-oxide electrode. Even in the quiescent state, the cell slowly self-discharges. In the event of an extreme exhaustive discharge, electrodes may become unusable in many cases, leading to a total loss of the storage battery.

Nitrogen compounds have been discussed as a mechanism of this unwanted self-discharging, which, by undergoing reduction at the negative electrode and oxidation at the positive electrode, are responsible for the transport of the electrons.

The influence of different separator materials on the self-discharging of nickel-cadmium or of nickel-metal-hydride storage batteries is discussed in the technical literature (P. Kritzer; J. Power Sources 2004, 137, 317-321).

The purpose of the separator material that is used is to lessen or suppress the self-discharging. This is presently accomplished in that the separator slows the discharging process by trapping ammonia.

At the present time, such ammonia-binding separators are manufactured in a process which includes the additional operational step of treating nonwoven polyolefin fabrics. The desired properties can be obtained both by the grafting of acrylic acid, as well as by sulfonation using concentrated sulfuric acid. This disadvantageously entails a second operational step following manufacture of the nonwoven fabric. Products manufactured using these production methods are commercially available, for example, from the firm Japan Vilene Co., JP (sulfonated materials) or from the firm Scimat Ltd., UK (materials grafted with acrylic acid).

Another manufacturing process includes the application of ammonia-absorbing powders or dispersions. In this context, polyolefins grafted with acrylic acid are used. Here, the disadvantage arises that “sealed locations,” which can degrade the battery's performance, can form in such products, in the area of the applied particles. Products manufactured using this method are commercially available from the firm Freudenberg Vliesstoffe (Freudenberg Nonwovens) KG, Weinheim, Germany.

The nonwoven fabrics of the type described have considerable drawbacks with regard to their manufacture and later use.

### SUMMARY OF THE INVENTION

An object of the present invention is to devise a galvanic cell which, in the context of a simple and trouble-free manufacturing, is characterized by a long service life. The present invention provides a nonwoven fabric including functional fibers made of at least one fibrous material intrinsically containing at least one substance chemically active or activatable in an alkaline medium, the substance being incorporated surface-actively in volumetric regions of the functional fibers whose surface areas are able to be acted upon by the medium.

Properties of a galvanic cell may be determined by the nonwoven fabric used in the galvanic cell or by the fibers used in the galvanic cell. Chemically active or activatable substances may be used effectively and selectively by incorporating them in the fiber matrix and distributing them in the same. By selectively allocating the chemically active substances to merely those regions which are able to come in contact with the medium, an economical and effective use of the substances may be rendered possible. In this respect, only that portion of the fiber matrix requiring modification may be modified by the chemically active substances. This may eliminate a possibility of the overall structure of the fibers being disadvantageously affected by the modification. Incorporating the chemically active substance ensures that, as soon as substances are consumed at the surface, they can be replenishable from the inside of the volumetric region. This ensures an especially long service life for the galvanic cell.

The functional fibers may include multicomponent fibers. These fiber types are easily manufactured since the methods for manufacturing the same are already well known.

Given these facts, the multicomponent fibers may conceivably include side-by-side fibers. Commercial side-by-side fibers are easily obtained.

To achieve such a stabilization, the fibers may include core-sheath fibers, it being necessary for the core to provide the stabilizing action.

Exclusively one component of the multicomponent fibers may include the substance. This specific embodiment ensures that regions may be created in the fiber whose structures are not affected by the modification produced by the substance.

The sheath component of a core-sheath fiber may contain the substance. This may make it feasible for the substance to interact with the alkaline medium over the entire peripheral region of a fiber. In this respect, an especially large reactive surface area may be realized.

The nonwoven fabric may include a fiber blend having a functional fiber content of at least 15% by weight. The lower bound of 15% by weight represents a value at which a long enough discharge duration may be achieved for the galvanic cell. If fewer functional fibers are used, then the self-discharging may be too fast, and the battery may not have an advantage over batteries equipped with conventional separators.

At least one substance may be constituted of a polymer formed by copolymerization. A copolymerization process produces a material having an especially homogeneous and stable internal structure. This ensures an especially advantageous distribution of chemically active molecules in a volume.

At least one substance may be constituted of a polymer formed by grafting. In particular, the functional polymers present in the melt or solution or dispersion may conceivably be grafted with acrylic acid and subsequently spun into fibers. Alternatively thereto, the fibers may be grafted with acrylic acid in a dispersion following the spinning process. The fibers may be subsequently further processed in downstream processes into a nonwoven fabric, without undergoing any further chemical modification.

The fibers may be functionalized using copolymerization or grafting processes in which the polymers are reactively extruded and, as a result, possess functional groups in the molecule or form the same in the alkaline electrolyte that are capable of binding ammonia from the alkaline solution. In this context, the polymers may contain functional groups that are active as Lewis acids in the alkaline medium. This specific embodiment ensures that the functional fibers can bind ammonia in the alkaline solution. This effectively may slow a discharging of the galvanic cell.

The polymers may include polypropylene (PP), polyethylene (PE) or other polyolefins. In the context of a trouble-free manufacturing, it is advantageous to use such polymers, since their material properties are known and manufacturing processes are able to be easily calculated and reproduced.

The fibrous material may also be conceivably functionalized in bulk using copolymerization or grafting processes in which a polyolefin, polystyrene, polyphenylene sulfide, polysulfone, ethylene vinyl alcohol or blends thereof are reactively extruded. Likewise conceivable may be a grafting process in a polymer dispersion.

The nonwoven fabric may be characterized by an ammonia absorbing capacity of at least 0.1 mmol per g of nonwoven fabric weight. This absorbing capacity ensures that the discharge process in the galvanic cell is sufficiently retarded.

In an especially preferred aspect, a nonwoven fabric may bind at least 0.1 mmol NH3/g of nonwoven composition, 0.2 mmol NH3/g or at least 0.4 mmol NH3/g of nonwoven composition. These selected values represent characteristic values at which the discharge duration may be clearly prolonged.

The nonwoven fabric may include a fiber blend having fibers that are resistant to hydrolysis in concentrated alkaline solution. This ensures that the nonwoven fabric has a stable structure and does not decompose in an alkaline medium.

To achieve good wettability, the nonwoven fabric may have hydrophilic properties, in particular hydrophilic surfaces. These may be obtained in a fluorination process, a plasma treatment or in a sulfonation process. It also may be conceivable for the nonwoven material to be grafted with polar, unsaturated, organic substances. In this context, it is also conceivable for a wetting agent to be applied. Commercial wetting agents can be easily obtained.

The nonwoven fabric may have a substance weight of 15 to 300 g/m². This range ensures that the nonwoven fabric has an adequate fluid absorbing capacity and, at the same time, makes it possible to produce a galvanic cell having a practical weight.

The nonwoven fabric may have a thickness of 20 to 400 μm. This range makes it feasible to produce a galvanic cell having practical internal and external dimensions.

The nonwoven fabric may be fabricated using a wet-laid nonwoven technology. This type of manufacturing ensures that the nonwoven fabrics are highly homogeneous.

It also may be conceivable to manufacture the nonwoven fabric in accordance with a dry-laid nonwoven technology. When this technology is used, no media act on the nonwoven material that would negatively affect the stability of the same.

The nonwoven fabric may also be fabricated using a spunbond-meltblown technology. This type of fabrication makes it possible to manufacture very thin fibers and, therefore, nonwoven fabrics having a high specific surface area.

The present invention may also provide a fiber having a fibrous material, containing at least one substance chemically active or activatable in an alkaline medium, the substance being incorporated surface-actively in volumetric regions of the fiber whose surface areas are able to be acted upon by the medium. In order to avoid repetitive descriptions of the inventive step, reference is made to the practical implementation of the same in the production of nonwoven fabric.

The fibers may have a diameter that is smaller than 5 μm. This makes it possible for super-fine fibers, i.e. microfibers, to be used, resulting in a nonwoven fabric having a large surface area.

The fibers may be spun from a fibrous material that was only functionalized by the substance after the spinning process. This embodiment makes it possible to produce functional fibers from commercially purchased fibers. In this respect, the fibers may be fabricated and modified at two separate locations.

The fibers may also conceivably be spun from a fibrous material that is functionalized by the substance. This makes it possible for the functional fibers to be produced at one location.

The fiber or a multiplicity of fibers may exist in a highly fibrillated state. This embodiment permits the use of pulp material to manufacture nonwoven fabrics. Pulp material has the features of an exceptionally high surface area.

The fibers claimed in this application may be characterized by a geometric or material form consistent with that of the fibers contained in the nonwoven fabrics described here. In particular, all fiber types, for example core-sheath fibers or the like, may conceivably be selected as a geometric form. In addition, the substances named as fibrous material in this application or used for functionalization purposes may conceivably be used in all practical combinations.

The present invention also provides a galvanic cell including a casing at least partially accommodating at least one positive and one negative electrode, a material permitting transport of charge carriers, and a separator separating the positive or negative electrodes, the separator including a fiber.

### BRIEF DESCRIPTION OF THE DRAWINGS

FIG. 1 shows a side-by-side fiber.

FIG. 2 shows a core-sheath fiber.

FIG. 3 shows a galvanic cell.

### DETAILED DESCRIPTION OF PREFERRED EMBODIMENTS

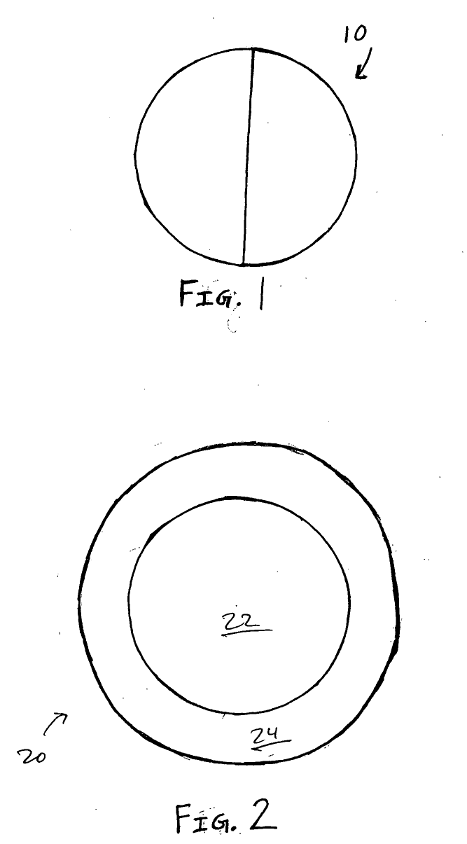

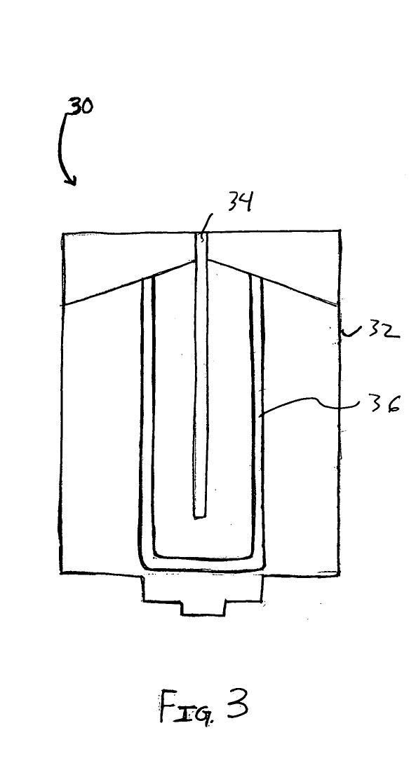

The present invention may be advantageously embodied and further refined in different ways. FIG. 1 shows a side-by-side multicomponent fiber 10 and FIG. 2 shows a core-sheath fiber 20 with a core 22 and sheath 24. FIG. 3 shows a galvanic cell 30 having a casing 32, a transport material 34 and a separator 36 made of nonwoven fabric according to the present invention.

A) Ammonia-binding polyolefin fibers were produced by way of example, using the following processes:

1. Use of an acrylic acid-grafted polypropylene having an acrylic acid concentration of 5.5%.

Fibers were spun at extruder temperatures from 210-215° C. The spinning nozzle had an aperture of 450 μm. The polymer throughput rate was 0.11 cm³/min per nozzle. The fibers were subsequently drawn with a draw ratio of 3 at temperatures of between 80 and 100° C. The resulting fibers had a titer of approximately 2.5 dtex; the ammonia absorption capacity was 0.58 mmol NH3/g.

2. Use of an acrylic acid-grafted polyethylene having an acrylic acid concentration of 6.0%.

Fibers were spun at extruder temperatures from 205-210° C. The spinning nozzle had an aperture of 450 μm. The polymer throughput rate was 0.13 cm3/min per nozzle. The fibers were subsequently drawn with a draw ratio of 3 at temperatures of between 80 and 100° C. The resulting fibers likewise had a titer of approximately 3 dtex; the ammonia absorption capacity was 0.51 mmol NH3/g.

3. Use of a core-sheath fiber having a “core” of polypropylene and a “sheath” of an acrylic acid-grafted polyethylene.

As a core polymer, a polypropylene type from the firm Borealis, Denmark, having an MFI value of 37 at 210° C. was used. The MFI value is known as the so-called melt flow index, which represents the melt flow of a material through a nozzle of a defined diameter at specified pressure and temperature conditions. As a sheath polymer, the modified polyethyelene named in practical example 2 was used. The core/sheath ratio was 50:50. A titer of approximately 1.7 dtex was obtained for the fibers. The ammonia absorption capacity of the fibers was 0.38 mmol NH3/g.

4. Use of a polypropylene fiber for the melt blown process.

Polypropylene of the firm Borealis, Denmark, having an MFI value of 800 was functionalized and spun at T=270° C. A fiber diameter of 4 μm was obtained.

5. Modification of supplied short-cut fibers.

To this end, core-sheath fibers of polyolefin from the firm Daiwabo were used. These had a cut length of 6 mm and a titer of 0.8 dtex. These fibers were acrylic acid-grafted in a dispersion. The modified fibers had an ammonia absorption capacity of 0.3 mmol NH3/g.

B) Nonwoven fabrics were produced from the fibers of practical examples A) 1. through A) 5. In the process, short-cut fibers having lengths of 6 mm were used as functionalized fibers.

1. Use of the modified PP fibers named under A) 1.

The fibers were dispersed with polyolefin core/sheath fibers having a titer of 0.8 dtex (firm Daiwabo, Japan) in a blend ratio of 60:40, and a nonwoven was wet-laid. The nonwoven formed having a substance weight of 60 g/m² was subsequently thermally bonded at approximately 135° C. and calendered to a thickness of 140 μm. The measured ammonia bonding capacity was 0.32 mmol NH3 per g of nonwoven fabric.

2. Use of the modified PE fibers named under A) 2.

The fibers were dispersed with unblended polypropylene fibers having a titer of 0.8 dtex (firm Daiwabo, Japan) in a blend ratio of 40:60, and a nonwoven was wet-laid. The nonwoven formed having a substance weight of 60 g/m² was subsequently thermally bonded at approximately 140° C. and calendered to a thickness of 140 μm. The measured ammonia bonding capacity was 0.24 mmol NH3 per g of nonwoven fabric.

3. Use of the modified core-sheath fibers named under A) 3:

The unblended fibers were dispersed, and a nonwoven was wet-laid. The nonwoven formed having a substance weight of 60 g/m² was subsequently thermally bonded at 140° C. and calendered to a thickness of 140 μm. The measured ammonia bonding capacity was 0.39 mmol NH3 per g of nonwoven fabric.

In another example, 70% of the core-sheath fibers were dispersed with 30% unblended polypropylene fibers having a titer of 0.8 dtex (firm Daiwabo, Japan), and a nonwoven was wet-laid. The nonwoven formed having a substance weight of 60 g/m² was subsequently thermally bonded at 140° C. and calendered to a thickness of 140 μm. The measured ammonia bonding capacity was 0.28 mmol NH3 per g of nonwoven fabric.

4. Use of the modified PP fibers named under A) 1., together with the modified core-sheath fibers named under A) 3:

The two fibers were dispersed in a blend ratio of 70:30, and a nonwoven was wet-laid. The nonwoven formed having a substance weight of 60 g/m² was subsequently thermally bonded at 140° C. and calendered at a nip pressure of 10 N/mm to a thickness of 140 μm. The measured ammonia bonding capacity was 0.42 mmol NH3 per g of nonwoven fabric.

5. Use of the short-cut fibers modified under A) 5:

The fibers were dispersed, and a nonwoven was wet-laid. The nonwoven formed having a substance weight of 60 g/m² was subsequently thermally bonded at 140° C. and calendered to a thickness of 140 μm. The measured ammonia bonding capacity was 0.3 mmol NH3 per g of nonwoven fabric.

6. Comparative example (blank test):

As a comparative example, one utilized the commercially available product FS 2226-14 of Freudenberg Vliesstoffe (Freudenberg Nonwovens) (substance weight of 60 g/m², thickness of 140 μm), which is made of unmodified polyolefin fibers. The measured ammonia bonding capacity was 0 mmol NH3 per g of nonwoven fabric.

C) Meltblown nonwoven fabrics made of polymers:

Using the modified polypropylene described under A) 4., a nonwoven fabric having a substance weight of 35 g/m² and a thickness of 120 μm was produced with the aid of meltblown technology and at spinning temperatures of about 270° C. The fiber thicknesses of the material were within the range of 2-4 μm. The nonwoven fabric had an ammonia bonding capacity of 0.62 mmol NH3 per g.

D) Battery results with respect to self-discharging:

The nonwoven separators manufactured in B) or C) were installed in batteries and tested to determine their effect on self-discharging. To this end, five nickel-metal-hydride AA size cells having a capacitance of 1200 mAh and containing separators in accordance with B) 3., B) 4., B) 5. and C) or comparative example B) 6, were manufactured. The self-discharging was measured under different conditions.

To determine the ammonia bonding capacity, a process including the following steps was carried out:

Approximately 2 g of the separator material were stored in 120 ml of an 8 molar potassium hydroxide solution (KOH) with the addition of 5 ml of 0.3 molar ammonia (NH₃) for three days at 40° C. Two blank tests were simultaneously prepared without any starting polymer. Following storage, filter paper was used to take up and remove any oily deposits existing on the surface. From the original 125 ml of the batch, a 100-ml aliquot was taken, and the ammonia was removed by steam distillation and collected in 150 ml of distilled water to which 10 ml of 0.1 molar hydrochloric acid (HCI) and a few drops of methyl red indicator had been added. The acid was subsequently back-titrated with 0.1 normal sodium hydroxide solution (NaOH).

The following table shows the self-discharging (SD) results obtained for the batteries manufactured using the nonwoven fabric separator materials mentioned.

| | Ammonia | | | |
|---|---|---|---|---|
| | absorption | SD (%) | SD (%) | SD (%) |
| Separator | (mmol/g) | (28 d, 20° C.) | (7 d, 45° C.) | (3 d, 60° C.) |
| FS 2226-14 | 0 | 28-30 | 33-36 | 60-65 |
| (blank test) | | | | |
| B) 3. | 0.28 | 21-24 | 24 | 34 |
| B) 4. | 0.42 | 20 | 21 | 29 |
| B) 5. | 0.30 | 21 | 22 | 32 |
| C) | 0.62 | 18 | 15 | 16 |

It turned out that the ammonia-binding separator materials manufactured in the context of the present investigation yield a clearly improved battery performance with respect to its self-discharge characteristics than do separators which do not have any ammonia-binding capability.

With regard to other advantageous embodiments and refinements of the teaching of the present invention, reference is made, on the one hand, to the general portion of the specification and, on the other hand, to the appended claims.

Finally, it is especially emphasized that the above practical examples, are merely intended for purposes of discussing the teaching of the present invention, but not for limiting it to such practical examples.

What is claimed is:

1. A nonwoven fabric comprising:
functional fibers made of at least one fibrous material intrinsically containing at least one substance chemically active or activatable in an alkaline medium,
the substance being incorporated surface-actively in volumetric regions of the functional fibers, the fibers having surface areas capable of being acted upon by the alkaline medium.

2. The nonwoven fabric as recited in claim 1 wherein the functional fibers include multicomponent fibers.

3. The nonwoven fabric as recited in claim 2 wherein the multicomponent fibers include side-by-side fibers.

4. The nonwoven fabric as recited in claim 2 wherein the multicomponent fibers include core-sheath fibers having at least one core component and at least one sheath component.

5. The nonwoven fabric as recited in claim 2 wherein exclusively one component of the multicomponent fibers includes the substance.

6. The nonwoven fabric as recited in claim 2 wherein an external component of the multicomponent fibers contain the substance.

7. The nonwoven fabric as recited in claim 1 further comprising other fibers, the functional fibers and other fibers having a functional fiber content of at least 15% by weight.

8. The nonwoven fabric as recited in claim I wherein the at least one substance includes a polymer formed by copolymerization.

9. The nonwoven fabric as recited in claim 1 wherein the at least one substance includes a polymer formed by grafting.

10. The nonwoven fabric as recited in claim 8 wherein the polymer contains functional groups active as Lewis acids in the alkaline medium.

11. The nonwoven fabric as recited claim 8 wherein the polymer includes polypropylene.

12. The nonwoven fabric as recited in claim 8 wherein the polymer includes polyethylene.

13. The nonwoven fabric as recited in claim 8 wherein the polymer includes polyolefins.

14. The nonwoven fabric as recited in claim 1 wherein the fabric has an ammonia absorbing capacity of at least 0.1 mmol per g.

15. The nonwoven fabric as recited in claim 1 wherein the functional fibers are located in a fiber blend resistant to hydrolysis in concentrated alkaline solution.

16. The nonwoven fabric as recited in claim 1 wherein the fabric has hydrophilic properties.

17. The nonwoven fabric as recited in claim 16 wherein the fabric is fluorination treated.

18. The nonwoven fabric as recited in claim 16 wherein the fabric is plasma treated.

19. The nonwoven fabric as recited in claim 16 wherein the fabric is sulfonation treated.

20. The nonwoven fabric as recited in claim 16 wherein the nonwoven fabric is grafted with polar, unsaturated, organic substances.

21. The nonwoven fabric as recited in claim 16 wherein the fabric is hydrophilized using a wetting agent.

22. The nonwoven fabric as recited in claim 1 wherein the at least one substance includes a substance weight of 15 to 300 g/m².

23. The nonwoven fabric as recited in claim 1 wherein the fabric has a thickness of 20 to 400 μm.

24. The nonwoven fabric as recited in claim 1 wherein the fabric is fabricated using a wet-laid nonwoven.

25. The nonwoven fabric as recited in claim 1 wherein the fabric is fabricated using a dry-laid nonwoven.

26. The nonwoven fabric as recited in claim 1 wherein the fabric is a spunbond-meltblown fabric.

27. The nonwoven fabric as recited in claim 9 wherein the polymer contains functional groups active as Lewis acids in the alkaline medium.

28. The nonwoven fabric as recited claim 9 wherein the polymer includes polypropylene.

29. The nonwoven fabric as recited in claim 9 wherein the polymer includes polyethylene.

30. The nonwoven fabric as recited in claim 9 wherein the polymer includes polyolefins.

31. A fiber comprising:
a fibrous material, containing at least one substance chemically active or activatable in an alkaline medium,
the substance being incorporated surface-actively in volumetric regions of the fibrous material, the fibrous material having surface areas able to be acted upon by the medium.

32. The fiber as recited in claim 31 further comprising a diameter of the fiber being smaller than 5 μm.

33. The fiber as recited in claim 31 wherein the fibrous material is functionalized by the substance after a spinning process.

34. The fiber as recited in claim 31 wherein the fiber is a spun fiber, spun from a fibrous material functionalized by the substance.

35. The fiber as recited in claim 31 wherein the fiber is a highly fibrillated fiber.

36. A galvanic cell comprising:
a casing at least partially accommodating at least one positive and one negative electrode,
a material permitting transport of charge carriers, and
a separator separating the positive and negative electrodes,
the separator including a fiber as recited in claim 31.

37. A separator in batteries or galvanic cells comprising the nonwoven fabric as recited in claim 1.

38. A galvanic cell as recited in claim 36 wherein the galvanic cell is a battery.
